(19) United States
(12) Patent Application Publication
(10) Pub. No.: US 2010/0274589 A1
(43) Pub. Date: Oct. 28, 2010

(54) METHOD FOR OUTPUTTING MEDICAL DOCUMENTS

(76) Inventors: Gottfried Bauer, Wien (AT); Friedrich Faustmann, Wr Neustadt (AT); Stefan Starke, Wien (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/764,485

(22) Filed: Apr. 21, 2010

(30) Foreign Application Priority Data
Apr. 22, 2009 (DE) 10 2009 018 423.6

(51) Int. Cl. G06Q 50/00; G06F 17/30; G06Q 10/00

(52) U.S. Cl. 705/3; 707/754; 707/E17.059

(57) ABSTRACT

A method for outputting medical documents on a terminal device is provided. The medical documents are generated and archived in a system structure for sharing medical data complying with the “Integrating the Healthcare Enterprise” guidelines. The medical documents are stored in special medicine-specific data formats containing user and meta information. A terminal device is selected; a web-based service is invoked from a server connected to the terminal device via a communication network. A patient identification is input via the terminal device and sent to the server, a terminal device type being identified by the server. Patient-specific medical documents are ascertained by the server based upon the patient identification. The medicine-specific data formats are edited by the server such that the user and meta information is suitable for output and handling on the terminal device via the web-based service. The medical documents are forwarded by the server to the terminal device.

### CROSS REFERENCE TO RELATED APPLICATIONS

This application claims priority of German Patent Application No. 10 2009 018 423.6 DE filed Apr. 22, 2009, which is incorporated by reference herein in its entirety.

### FIELD OF INVENTION

The present invention relates to a method for outputting medical documents, in particular recordings and findings from specialist medical fields such as e.g. radiology, cardiology and/or laboratory diagnostics, on any types of terminal device—for example a so-called smartphone, a personal digital assistant (PDA), personal computer, flat screen, etc. In this case the medical documents are generated in an “Integrating the Healthcare Enterprise”—IHE for short—compliant system structure for sharing medical data and are stored in said system structure in digital form in medicine-specific data formats which include user and meta information.

### BACKGROUND OF INVENTION

At the present time in the healthcare sector patient data (e.g. name, sex, age, social security number, etc.) and also patient-specific medical documents (e.g. diagnostic findings, laboratory reports, recordings and/or operative reports from different special medical fields such as, for example, radiology, cardiology, laboratory diagnostics, etc.) are no longer archived just in paper form or on film, but very often are also stored in the form of digital data. For this reason special information technology (IT) systems are deployed in/by various healthcare institutions such as e.g. hospitals, laboratories, radiology laboratories, medical practices, etc. for the purpose of managing said patient-specific and medical information in digital form, said IT systems being tailored to the particular needs of the individual institution.

Examples of such IT systems in the healthcare sector include hospital information systems (HIS), systems for specialized hospital areas (e.g. intensive care unit information system), laboratory information management systems (LIMS), radiology information systems (RIS), image archiving and communication systems, management systems for medical practices (PVS), etc. Hospital information systems, for example, include all the software and hardware components for administrative management and financial management of a hospital. Information stored in them includes, for example, patient data, medical records, treatment paths, care and resource planning, as well as financial and accounting data, etc. Laboratory information management systems are used e.g. for performing the data processing in chemical, physical, biological or medical laboratories inside and outside of a hospital.

In the radiology field, radiology information systems are used e.g. for documentation and management of medical and administrative data. Said systems comprise, for example, functions such as management of patient data, appointments scheduling, documentation of medical data, processing of accounting data, generation of radiological findings, etc. In addition, however, radiology information systems also provide interfaces to digital imaging medical systems such as e.g. digital X-ray, computed tomography (CT), magnetic resonance tomography (MRT) systems, etc.

An image archiving and communication system having a shared memory area is often deployed e.g. in a hospital or also in a radiology laboratory for processing and archiving image data generated by imaging medical systems and methods such as e.g. X-ray systems, CT, MRT, ultrasound, endoscopy, etc. Said image archiving and communication system is also referred to as a so-called Picture Archiving and Communication System (PACS).

Various standards, such as e.g. Health Level 7 (HL7), and standardized medicine-specific data formats and types (e.g. Digital Imaging and Communication in Medicine (DICOM), Clinical Document Architecture (CDA), etc.) have been developed in order to promote the integration of different system components e.g. in the case of a PACS system and/or the embedding of e.g. a PACS system in a radiology and/or hospital information system.

As well as being the name for the corresponding organization by which these healthcare standards are developed and supported, HL7 is also used as the designation for the standards themselves. The HL7 standards consist of a group of international standards for data interchange between organizations from the healthcare sector (e.g. hospitals, laboratories, medical practices, social insurance agencies, etc.) and their IT systems. The HL7 standards are intended to promote improved interoperability between different information systems in the healthcare sector, such as e.g. hospital information systems, practice management systems, laboratory information management systems, radiology information systems, systems for service accounting, etc.

In the radiology field, Digital Imaging and Communication in Medicine, or DICOM for short, is used as a standardized data format or data type, for example. In this field DICOM represents a standard for handling, storing, printing and transmitting digital images in medicine by means of which interoperability between different medical systems from possibly different manufacturers is to be supported and improved. DICOM is therefore used e.g. by almost all medical imaging systems and methods (e.g. digital X-ray equipment, CT, MRT, etc.) as well as by PACS systems. Basically DICOM provides a number of data models according to which the DICOM data can be structured. Regardless of the data model used in a particular case, a DICOM data set always includes user information (e.g. pixel or image data from digital X-ray equipment, CT, MRT or another imaging method, PDF data or other binary data) and meta information. Under DICOM the meta information is stored in what is termed a header and constitutes explanations relating to the respective user information or image data. Such meta information includes, for example, patient name, image generation date, device parameters, physician name, etc.

A standardized data format developed by the HL7 standardization organization is, for example, Clinical Document Architecture, or CDA for short. CDA is an Extensible Markup Language (XML) based standard for sharing and storing clinical content such as e.g. physician referral letters, reports on diagnostic findings, medication plans, etc. A medical document stored in CDA data format, like a DICOM document, likewise consists of user and meta information. The user information is e.g. clinical content such as e.g. diagnoses, medication, treatments, etc. stored in the form of a readable text. The meta information can include, for example, patient name, physician name, clinical illness codes or diagnostic codes. In addition the user information can also be supplemented by information blocks which can also be used by computer applications, such as, for example, machine-readable details concerning the diagnosis or laboratory values.

Usually the different standards and data formats are tailored only to subareas of the healthcare system. For example, DICOM is used mainly in the field of imaging systems and methods. This is the reason for the attempt by the “Integrating the Healthcare Enterprise (IHE)” initiative to harmonize the data and information exchange between the computer systems in the healthcare sector and on the basis of the existing standards and standardized data formats (e.g. HL7, DICOM, CDA, etc.). In the IHE the primary focus is on a digital conversion of medical process flows between the computer systems. The IHE has therefore formulated requirements from practice in so-called “use cases”, identified relevant standards such as e.g. HL7, DICOM, CDA, etc., and developed technical guidelines—called profiles—for different specialist medical fields, on the basis of which healthcare products, for example, can be implemented and tested.

One of these profiles is an IHE-compliant system structure for exchanging medical data—the so-called Cross-Enterprise Document Sharing (XDS) structure. By means of this system structure it is made easier for different institutions, from medical practices to hospitals and emergency hospitalization to patient information systems, to exchange or, as the case may be, obtain distributed access to a patient's digital medical documents. The IHE-compliant Cross-Enterprise Document Sharing structure is described, for example, in the following IHE documents: “IHE IT Infrastructure Technical Framework Vol. 1, Section 10, Rev. 5.0, IHE International, 2008” and “IHE IT Infrastructure Technical Framework Supplement 2007-2008, Cross-Enterprise Document Sharing XDS.b, Draft for Trial Implementation, 10.10.2008”. By means of the Cross-Enterprise Document Sharing structure according to IHE guidelines a system structure is provided which enables medical documents to be retrieved on a patient-specific basis, said documents being generated and made available as document sources by one or more information systems in the healthcare sector and/or medical imaging systems (e.g. digital X-ray, CT, MRT, etc.).

In this scheme the Cross-Enterprise Document Sharing structure includes what is called a Document Registry, in which information (e.g. document name, type, reference address, etc.) for locating medical documents is stored, and at least one so-called Document Repository. The at least one Document Repository is responsible for transparent and secure storage of the medical documents, wherein the medical documents can be stored e.g. in the Document Repository itself or information is stored indicating by which information or IT system in the healthcare sector (e.g. PACS) the medical documents can be retrieved.

In the Cross-Enterprise Document Sharing structure according to IHE guidelines, medical documents are queried by what is termed a Document Consumer, by which the desired medical documents are also retrieved from the at least one Document Repository of the Cross-Enterprise Document Sharing structure. For example, a specialist system (e.g. systems in the hospital sector, etc.) which is already specifically tailored for accessing and displaying can be used as a Document Consumer for querying and displaying medical documents. It is, however, also possible, for example, for a personal computer (PC) or a computer system in the medical practice sector to be used as a Document Consumer.

That said, however, a Document Consumer (e.g. PC, computer in a medical practice, etc.) must have access to the internet in order to access medical documents of the Cross-Enterprise Document Sharing structure, since standard internet protocols (e.g. Hypertext Transfer Protocol (http), etc.) and “Electronic Business using XML” (Extensible Markup Language) are used for communicating with the Document Registry and the at least one Document Repository of the Cross-Enterprise Document Sharing structure. Data or, as the case may be, the medical documents queried by the Cross-Enterprise Document Sharing structure must then be interpreted by the respective Document Consumer and edited for display.

However, it is disadvantageous that the terminal device (e.g. PC, etc.) used as the Document Consumer must be equipped for displaying medical documents. The formats or data types in which the medical documents are stored in the Cross-Enterprise Document Sharing structure can range, for example, from a simple image or text file through medical diagnostic findings in. CDA format to a complex image sequence in DICOM.

If, for example, medical documents of the Cross-Enterprise Document Sharing structure are accessed by a physician in his/her medical practice in the course of a patient consultation by means of a PC or computer system serving for medical practice administration, terminal-device-specific software components for each medicine-specific data format used (e.g. CDA, DICOM) must be installed beforehand in order to display said documents. It has consequently proved disadvantageous that in order to perform a function as Document Consumer a terminal device must be equipped at high additional cost with terminal-device-specific and data-format-specific software components in order to be able to query and display medical documents. In addition there exists for a user (e.g. patient, physician) an option of choice in the case of the terminal device or, as the case may be, no possibility of changing the terminal device without additional expenditure, since the correspondingly equipped terminal device must always be used for accessing medical documents of the Cross-Enterprise Document Sharing structure.

### SUMMARY OF INVENTION

An object of the invention is to disclose a method by which medical documents which are stored in different medicine-specific data formats can be output on an arbitrarily chosen terminal device and displayed in a form adapted to said arbitrarily chosen terminal device, without incurring additional costs.

This object is achieved by a method, wherein firstly a terminal device is selected and by means of the chosen terminal device a web-based service is invoked from a server connected to said terminal device via a communication network (e.g. data network, radio network, etc.). With the aid of the web-based service a patient identification is input via the chosen terminal device and sent to the server, a terminal device type of the chosen terminal device (e.g. PDA, smartphone, PC, computer with flat screen, etc.) being identified by the server. Patient-specific medical documents that are available in the system structure for sharing medical data are then ascertained by the server on the basis of the patient identification and the medicine-specific data formats of the medical documents ascertained in each case are edited by the server in such a way that the user information and meta information of the medical documents is suitable for output and handling on the chosen terminal device with the aid of the web-based service. Said documents are then forwarded by the server to the chosen terminal device for output (e.g. in what is called a web browser).

The main aspect of the solution proposed according to the invention consists in the fact that without additional overhead, such as e.g. installation of terminal-device-specific and/or data-format-specific software components, medical documents can be retrieved and displayed by any arbitrary terminal device, in particular also a mobile terminal device. The terminal device (e.g. PDA, smartphone, PC, computer with flat screen, etc.) is only required to have a connection to the server via a communication network, a prerequisite being that the communication network must allow access to the internet. Data networks having a fixed connection to the server, such as e.g. local area networks (LANs) or wide area networks (WANs) or communication networks having a wireless connection to the server, such as e.g. radio networks (e.g. wireless LANs, mobile communication networks) can therefore be used as the communication network.

By means of the method according to the invention it is therefore possible to output medical documents in a simple, web-based and fully scalable manner, irrespective of the chosen terminal device, anywhere and anytime on a terminal device chosen by a user (e.g. physician, patient)—from a PDA or smartphone display to a large flat screen as the output unit of an associated computer. The method enables medical documents which are available in medicine-specific data formats (e.g. CDA, DICOM) to be displayed on the terminal device in accordance with the chosen terminal device as images, video, text, etc. without information loss or, as the case may be, with very little loss of information and according to the respective data type of the user and meta information.

In a preferred development of the inventive method, reference addresses of the available patient-specific medical documents in the system structure for sharing medical data are first ascertained by the server on the basis of the input patient identification. With the aid of the reference addresses a selection list of the available medical documents is generated by the server and displayed on the chosen terminal device with the aid of the web-based service. After at least one medical document has been selected from the selection list, the chosen document is retrieved by the server on the basis of an associated reference address in the system structure for sharing medical data and converted in such a way that the user and meta information of the chosen document can be displayed and handled on the chosen terminal device with the aid of the web-based service. This simplifies and shortens a search for desired medical documents and makes it available in a more clearly structured form for the chosen terminal device. In addition the document output on the chosen terminal device happens faster, since it is only necessary in the first instance to access the Document Registry in the system structure for sharing medical data, such as e.g. the Cross-Enterprise Document Sharing structure. The reference addresses for generating the selection list are then supplied to the server by the Document Registry, the reference addresses also being able to include information such as e.g. document name, data format of the document, date, specialist medical field, storage address within the system structure, etc.

It is advantageous if the selection list of the discovered medical documents is output on the chosen terminal device in a form structured according to date, according to type of the user information contained in the medical documents and/or according to medical criteria, in particular specialist field, medication usage, treating physician or treating hospital. In this simple way the user (e.g. physician, patient) can find the patient-specific documents of interest to him/her more quickly for selection—in particular in the case of terminal devices having a relatively small output unit, such as e.g. PDAs, smartphones, etc. For example, the user needs henceforth only to consider time periods of interest to him/her, types of user information (e.g. images, video, text) or specialist medical fields.

It is also favorable if the output of the patient-specific medical documents is pre-filtered by the server on the basis of search criteria which can be input via the web-based service. A pre-filtering of said kind is of advantage in particular in the case of terminal devices having a relatively small output unit, such as e.g. PDAs, smartphones, etc., since in that case a shorter selection list is displayed on the terminal device and consequently the search for a desired medical document is made simpler for the user. In the case of long and/or extensive patient health records also, the selection list can be restricted in this way for example to time periods of interest to the user, specialist fields, etc. of the medical documents or, as the case may be, also document types.

It is beneficial if, in addition to the patient identification, a physician authorization is also performed prior to output, display and handling of the medical documents. This advantageously enables a check to be carried out in accordance with various national data protection regulations to verify whether the particular user (e.g. physician) is authorized to inspect a specific medical document of a patient. By means of a check on a physician's authorization it is possible in a simple manner to prevent data protection regulations or a patient's privacy from being violated. Since medical documents such as e.g. diagnostic findings, medical reports, diagnoses, etc. are particularly sensitive data, it can be specified, e.g. by the respective patient, which physician or which hospital, etc. is authorized to inspect specific medical documents. It is of advantage in this case if the physician authorization to display and handle the medical documents can be set up and confirmed e.g. by the patient in a time-limited manner.

In this way it is possible for a patient to grant a treating physician (e.g. doctor on emergency call) access to important medical documents for a specific time period, in an emergency situation for example. A time limit can be set, for example, by input of a validity period for the physician authorization. A physician can e.g. also be granted time-limited access to a patient's medical documents by means of an invocation of the web-based service from the server by patient and physician in parallel and a subsequent activation of the physician authorization by the patient. After termination of the web-based service by the patient, the physician's time-limited authorization to inspect the patient-specific medical documents can be withdrawn again.

It is advantageous if the patient identification and/or the physician authorization can be read in from an identity card or input via the web-based service as password and personal identification number (PIN). For example, input of a password and a personal identification number (PIN) by the user (e.g. patient, physician) via a keyboard of the terminal device can be requested by the web-based service. Alternatively it is possible for the patient identification and/or the physician authorization to be read in from an identification card (e.g. electronic health card, etc.) by means of a card reader when an IC chip is used or by means of a barcode reader in the case of a barcode. For security reasons the user can additionally be requested to enter a PIN.

According to a beneficial development of the inventive method it is provided that what is termed a JavaServer Faces technology will be used by the web-based service for the terminal-device-specific display of the medical documents. JavaServer Faces is a so-called framework standard for developing user interfaces for web-based services. By using the JavaServer Faces technology it is possible to develop scalable user interfaces for the display on an arbitrarily chosen terminal device in a simple manner for the web-based service of the method according to the invention. This enables the user interface to be tailored to a display unit of the arbitrarily chosen terminal device, ranging from e.g. a PDA or smartphone, through a PC with monitor, to a computer having a flat screen or a flat screen projection screen.

It is favorable if medicine-specific data formats such as Digital Imaging and Communications (DICOM) in Medicine and/or Clinical Document Architecture (CDA) are converted by the server, since both DICOM and CDA are standardized data formats frequently used in the healthcare sector. DICOM is a standardized data format or, as the case may be, a standard for handling, storing, printing and transmitting digital images in medicine which is used in particular by medical imaging systems and methods (e.g. digital X-ray equipment, CT, MRT, ultrasound, endoscopy, etc.) as well as by PACS systems in which digital recordings from the radiology sector are archived. CDA is a data format standardized by the HL7 standardization organization or, as the case may be, a standard based on the Extensible Markup Language (XML) for exchanging and storing clinical content. For example, medical documents such as physician referral letters, diagnostic finding reports, clinical diagnoses, medication plans, etc. are stored in the CDA data format.

### BRIEF DESCRIPTION OF THE DRAWING

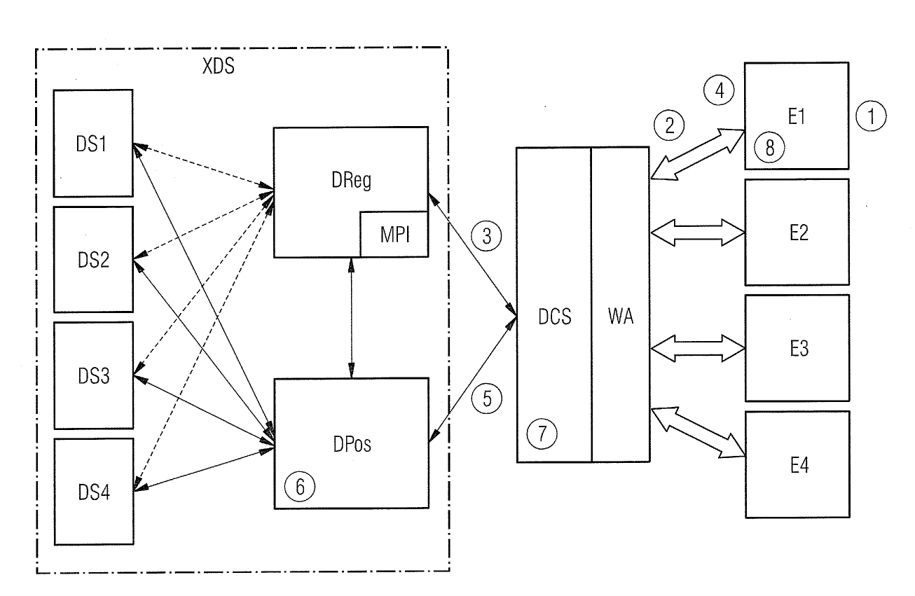

The invention is explained below in an exemplary manner with reference to the attached FIG. 1. FIG. 1 shows by way of example the process flow sequence of the inventive method for outputting medical documents.

### DETAILED DESCRIPTION OF THE INVENTION

FIG. 1 shows in a schematic and exemplary manner a system structure XDS for sharing medical data which complies with guidelines of the “Integrating the Healthcare Enterprise (IHE)” initiative. A system structure XDS of this kind is, for example, the so-called Cross-Enterprise Document Sharing structure, which is described e.g. in the documents IHE IT Infrastructure Technical Framework Vol. 1, Section 10, Rev. 5.0, IHE International, 2008 and IHE IT Infrastructure Technical Framework Supplement 2007-2008, Cross-Enterprise Document Sharing XDS.b, Draft for Trial. Implementation, 10.10.2008.

The system structure XDS for sharing medical data includes at least one document register DReg, at least one central, electronic document archive DPos as well as a plurality of document sources DS1, DS2, DS3, DS4, from which the medical documents are generated and made available.

Reference addresses of the medical documents, for example, are stored in the document register DReg, which is also referred to in a Cross-Enterprise Document Sharing structure as a Document Registry. These reference addresses include, for example, basic information relating to a medical document such as e.g. document name, data format of the document, date, specialist medical field, storage address within the system structure XDS, etc. In addition the document register DReg can also have a main directory MPI of patient identifications which includes content for the unique identification of a patient, such as, for example, patient name, a unique patient number (e.g. social security number), etc. The main directory MPI of the patient identifications can also be referred to as e.g. a master patient index (MPI).

The medical documents made available by the document sources DS1, DS2, DS3, DS4 are stored in the at least one central document archive DPos, which is also referred to in a Cross-Enterprise Document Sharing structure as a Document Repository. In addition the document archive DPos is also responsible for registering new medical documents in the document register DReg. Document sources DS1, DS2, DS3, DS4, from which medical documents are generated and/or made available are, for example, hospital or laboratory information systems, imaging medical systems (e.g. digital X-ray systems, CT, MRT, etc.) and/or image archiving and communication systems (e.g. PACS).

Medical documents such as e.g. X-ray, CT, MRT recordings, etc. as well as physician referral letters, diagnostic finding reports, clinical diagnoses, medication plans, etc. are generated from said document sources DS1, DS2, DS3, DS4. The medical documents are then made available to the at least one central document archive DPos of the system structure XDS for sharing medical data. In other words, the medical documents are either stored directly in the central document archive DPos or, in particular in the case of medical documents which include large volumes of data (e.g. X-ray, CT, MRT recordings, etc.), storage information for locating the respective medical documents is deposited in the central document archive DPos. A unique reference address is generated by the central document archive DPos for each medical document and forwarded to the document register DReg, where it is stored.

Document register DReg, the at least one central document archive DPos and the document sources DS1, DS2, DS3, DS4 of the system structure XDS are connected to one another for communication and data interchange purposes via a network (e.g. the internet) and typically are located in e.g. different hospitals, laboratories, medical practices and/or other healthcare institutions. Medical documents, for example, are handled in a neutral manner by the THE-compliant system structure XDS for sharing medical data. That is to say that the medical documents are registered, stored and managed independently of the particular medicine-specific data format. Thus, for example, common medicine-specific data formats such as DICOM, CDA, etc. are supported by a Cross-Enterprise Document Sharing structure, said data formats also comprising meta information (e.g. supplementary data relating to X-ray, CT, MRT images, coded clinical information, etc.) in addition to user information (e.g. X-ray images, CT or MRT recordings, diagnostic findings in text form).

A server DCS is connected to the system structure XDS for sharing medical data e.g. via a communication network (e.g. the internet). Communication between the server DCS and the document register DReg as well as the at least one central document archive DPos is handled via said communication network by way of, for example, internet protocols such as e.g. HTTP, HTTPs or XML.

Access to the server, which comprises a web-based service WA for accessing and outputting medical documents, can be effected via a communication network with the aid of terminal devices E1, E2, E3, E4 and in this way the web-based service can be invoked. Mobile terminal devices such as e.g. PDA, smartphone, laptop or PC with monitor or flat screen as the output unit can be provided as terminal devices E1, E2, E3, E4 for a user. The terminal devices E1, E2, E3, E4 have a connection to the server DCS via a hardwired (e.g. LAN, WAN) or wireless (e.g. wireless LAN, mobile communications network), said communication network being required to enable access to the internet. Within the context of the IHE Cross-Enterprise Document Sharing structure the combination of the server DCS having the web-based service WA and a terminal device E1, E2, E3, E4 arbitrarily chosen by a user in each case is also referred to as an Imaging Document Consumer.

In order to output medical documents that are archived in the system structure XDS for sharing medical documents, in a first method step 1 an arbitrary internet-capable terminal device E1, E2, E3, E4 currently available to a user (e.g. patient, physician) is chosen by the user. By selecting the server DCS via the internet the web-based service WA hosted on the server DCS is invoked and a homepage of the web-based service WA displayed in a so-called web browser for example on an output unit (e.g. display unit of PDA or smartphone, PC monitor, flat screen) of the chosen terminal device E1, E2, E3, E4.

In a second method step 2, the user is then prompted to enter an identification (e.g. patient identification, physician authorization). The patient identification or physician authorization can be input in the form of a password (e.g. social security number, patient name, physician ID, physician name, etc.) and PIN e.g. via a keyboard connected to the chosen terminal device E1, E2, E3, E4. Alternatively in the second method step 2, the patient identification or physician authorization can be input e.g. by reading in a barcode or by reading out an IC chip, the barcode or IC chip possibly being provided on the identity card (e.g. electronic health card, electronic health insurance card, etc.), which includes data such as e.g. patient name, social security number, etc. However, these possibilities are only available for identification of patient or physician if corresponding input devices such as e.g. card reader or barcode reader are available or can be attached in the case of the chosen terminal device E1, E2, E3, E4. For security reasons, after the patient identification or physician authorization has been read in, input of a PIN can also be required in addition. In the second method step 2 it is additionally ascertained by the server DCS which terminal device E1, E2, E3, E4 has been chosen for accessing the medical documents.

After password and PIN have been input or, as the case may be, read in, the entered patient identification or physician authorization is forwarded to the server DCS and in a third method step 3 a search query is then launched by the server DCS in the document register DReg of the system structure XDS for sharing medical data. In the case of a physician authorization being entered, the document register DReg or master patient index MPI is first searched to identify all those patient identifications (e.g. social security numbers) for which the physician possesses an authorization to inspect the associated medical documents. After input of the physician authorization, all those patient identifications for which the physician has authorization are displayed to him/her first, e.g. in the form of a selection list. Following verification of the physician authorization, the desired patient identification sent to the server DCS and input by a patient as the user already in method step 2 to allow inspection of his/her medical documents can be chosen by the physician. In addition it is also possible for a patient e.g. in an emergency situation to grant a physician a time-limited authorization to inspect his/her medical documents.

In the third method step 3, the available medical documents of the patient or, as the case may be, the corresponding reference addresses of said documents are then identified in the document register DReg on the basis of the patient identification read in or chosen by the physician. In a fourth method step 4, the reference addresses of the medical documents found in relation to the patient identification are then sent back to the server DCS by the document register DReg. The identified reference addresses of the medical documents are forwarded by the server DCS to the chosen terminal device E1, E2, E3, E4 and displayed there with the aid of the web-based service WA as a selection list of the medical documents available for a patient on the output unit (e.g. display, screen, etc.) of the chosen terminal device E1, E2, E3, E4 e.g. in a web browser and adjusted in size to the size of the output unit of the chosen terminal device E1, E2, E3, E4. For that purpose, in addition to a storage address of the document within the system structure XDS, the reference address of a medical document also includes information such as e.g. document name, data format of the document (e.g. text, image, video, etc.), date, specialist medical field, etc. In addition the selection list of the identified medical documents that is displayed on the chosen terminal device E1, E2, E3, E4 can be structured e.g. according to date, type of user information included (e.g. text, image, video, etc.) or according to medical criteria (e.g. specialist field, medication usage, treating physician, treating hospital, etc.) in order to locate desired medical documents more easily.

In a fifth method step 5, following selection of a desired medical document from the selection list displayed on the chosen terminal device E1, E2, E3, E4, the selected medical document is notified to the server DCS. The associated reference address already ascertained in the third method step 3 is then analyzed by the server DCS and a corresponding request for said medical document sent to the central document archive DPos. In a sixth method step 6, the desired medical document is retrieved by the central document archive DPos from the respective storage address—either in the central document archive DPos itself or in one of the document sources DS1, DS2, DS3, DS4 (e.g. PACS)—and sent to the server DCS.

In a seventh method step 7, the medical documents, which have been stored in a medicine-specific data format (e.g. DICOM, CDA) in the form of user and meta information and delivered to the server DCS, are then edited by the server DCS for output with the aid of the web-based service WA on the chosen terminal device E1, E2, E3, E4. This means that the medical data formats are converted in such a way that in an eighth method step 8 the user information and meta information contained in the respective document can be displayed and manipulated on the chosen terminal device E1, E2, E3, E4 by the web-based service WA e.g. in a terminal-device-specific web browser (e.g. in image form in the case of user information) or by means of software applications available on the terminal device (e.g. Windows Media Player, Quicktime, etc. for video; Adobe Acrobat Reader, MS Office for text data; etc.).

In the seventh method step 7, the user information and meta information stored in the medical documents in medicine-specific data formats (e.g. CDA, DICOM) is therefore converted by the server DCS on a terminal-device-specific basis into standard text, standard image and/or standard video formats such as, for example, pdf, jpeg, bitmap, mpeg, Audio Video Interleave (AVI), etc. In this case meta information is made visible e.g. as text, supplementary information, etc. In medical documents in CDA format (e.g. physician referral letters, diagnostic findings, etc.), which can contain further medical documents as what are termed embedded files, said embedded files are analyzed, for example. That is to say that the corresponding contents of the embedded files are ascertained by the server DCS in the system structure XDS for sharing medical data and likewise edited for output on the chosen terminal device E1, E2, E3, E4—insofar as this is useful based on the size of the display of the output unit of the chosen terminal device E1, E2, E3, E4.

In the eighth method step 8, the medical documents suitably edited by the server DCS are then forwarded to the chosen terminal device E1, E2, E3, E4 and a content of the medical documents is output on the respective output unit of the chosen terminal device E1, E2, E3, E4 with the aid of the web-based service WA. That is to say that the medical documents are either displayed in a terminal-device-specific web browser with the aid of the web-based service WA or an available and appropriate software application (e.g. Windows Media Player, Quicktime, etc. for video; Adobe Acrobat Reader, MS Office for text data; etc.) is launched with the aid of the web-based service on the chosen terminal device E1, E2, E3, E4 for the purpose of outputting the medical document.

An application tailored to the DICOM format (=a so-called DICOM viewer) is additionally provided in the method according to the invention for medical documents in DICOM format for the purpose of displaying user information (e.g. images, video, etc.) and meta information stored in what is termed a header (e.g. patient name, recording creation date, device parameters, physician name, etc.) if a PC or computer with flat screen has been chosen as the terminal device E1, E2, E3, E4 for outputting medical documents. The DICOM viewer is an application designed as what is termed a Java applet which is fully integrated into the web-based service WA. A Java applet is an application which has been written in the Java programming language and typically can be executed in a web browser. If, in the second method step 2, a PC or computer with flat screen—in other words a terminal device E1, E2, E3, E4 having an output unit with a relatively large surface area—is identified by the server DCS as the chosen terminal device E1, E2, E3, E4 and if, in the seventh method step 7, DICOM is identified as the data format of the chosen medical document, then in the eighth method step 8 the DICOM viewer is sent as well to the terminal device E1, E2, E3, E4 chosen for the output for the purpose of outputting the medical documents. Advantageously, the data management for the user and meta information of the medical document in DICOM format that is to be transmitted to the terminal device E1, E2, E3, E4 is also handled by the DICOM viewer.

By means of the method according to the invention it is thus possible to inspect medical documents e.g. in the event of patient queries, consultations, etc. anywhere and anytime from an arbitrary or, as the case may be, currently available terminal device E1, E2, E3, E4 in a simple manner and without additional overhead.

1.-9. (canceled)

10. A method for outputting medical documents on a terminal device, comprising:
generating and archiving the medical documents in an “Integrating the Healthcare Enterprise”-compliant system structure for sharing medical data;
storing the medical documents in medicine-specific data formats containing user and meta information;
selecting a terminal device and invoking a web-based service by the selected terminal device from a server connected to the terminal device via a communication network;
inputting a patient identification via the terminal device and sending the patient identification to the server, wherein a terminal device type of the selected terminal device is identified by the server;
ascertaining available patient-specific medical documents in the system structure by the server based upon the patient identification in order to share medical data;
editing the medicine-specific data formats of the medical documents by the server such that the user and meta information of the medical documents is suitable for output and handling via the web-based service on the terminal device; and
outputting and forwarding the medical documents by the server to the terminal device.

11. The method as claimed in claim 10, further comprising:
ascertaining reference addresses of the available patient-specific medical documents in the system structure in order to share medical data by the server based upon the input patient identification;
generating a selection list of the available medical documents by the server based upon the reference addresses and displaying the selection list on the chosen terminal device via the web-based service;
selecting a medical document from the selection list;
retrieving the selected medical document by the server based upon the associated reference address; and
converting the selected medical document such that the user and meta information of the medical document are displayed and handled on the terminal device via the web-based service.

12. The method as claimed in claim 10, wherein the selection list of the medical documents is output on the terminal device in a form structured according to date, according to type of the user information contained in the medical documents or according to medical criteria.

13. The method as claimed in claim 12, wherein the medical criteria are selected from the group consisting of specialist field, medication usage, treating physician, treating hospital and a combination thereof.

14. The method as claimed in claim 11, wherein the selection list of the medical documents is output on the terminal device in a form structured according to date, according to type of the user information contained in the medical documents or according to medical criteria.

15. The method as claimed in claim 14, wherein the medical criteria are selected from the group consisting of specialist field, medication usage, treating physician, treating hospital and a combination thereof.

16. The method as claimed in claim 10, further comprising:
pre-filtering the output of the patient-specific medical documents by the server based upon search criteria input via the web-based service.

17. The method as claimed in claim 11, further comprising:
pre-filtering the output of the patent-specific medical documents by the server based upon search criteria input via the web-based service.

18. The method as claimed in claim 10, further comprising:
verifying a physician authorization before displaying and handling the medical documents.

19. The method as claimed in claim 11, further comprising:
verifying a physician authorization before displaying and handling the medical documents.

20. The method as claimed in claim 18, wherein the physician authorization for displaying and handling the medical documents is set up on a time-limited basis.

21. The method as claimed in claim 19, wherein the physician authorization for displaying and handling the medical documents is set up on a time-limited basis.

22. The method as claimed in claim 10, wherein the patient identification is read in from an identity card or is input as a password and personal identification number via the web-based service.

23. The method as claimed in claim 18, wherein the physician authorization is read in from an identity card or is input as a password and personal identification number via the web-based service.

24. The method as claimed in claim 19, wherein the physician authorization is read in from an identity card or is input as a password and personal identification number via the web-based service.

25. The method as claimed in claim 10, wherein a so-called “JavaServer Faces Technology” is used by the web-based service for the terminal-device-specific display of the medical documents.

26. The method as claimed in claim 11, wherein a so-called “JavaServer Faces Technology” is used by the web-based service for the terminal-device-specific display of the medical documents.

27. The method as claimed in claim 10, further comprising:
converting medicine-specific data formats such as Digital Imaging and Communications into Medicine or Clinical Document Architecture by the server.

28. The method as claimed in claim 11, further comprising:
converting medicine-specific data formats such as Digital Imaging and Communications into Medicine or Clinical Document Architecture by the server.
